(19) United States
(12) Patent Application Publication
(10) Pub. No.: US 2014/0199622 A1
(43) Pub. Date: Jul. 17, 2014

(54) ERASABLE TONER

(71) Applicant: TOSHIBA TEC KABUSHIKI KAISHA, Tokyo (JP)

(72) Inventors: Takayasu AOKI, Shizuoka (JP); Takafumi HARA, Shizuoka (JP); Masahiro IKUTA, Shizuoka (JP); Tsuyoshi ITOU, Shizuoka (JP); Motonari UDO, Shizuoka (JP); Kazuhisa TAKEDA, Shizuoka (JP)

(73) Assignee: TOSHIBA TEC KABUSHIKI KAISHA, Tokyo (JP)

(21) Appl. No.: 14/156,968

(22) Filed: Jan. 16, 2014

(30) Foreign Application Priority Data
Jan. 17, 2013 (JP) 2013-006439

(51) Int. Cl. G03G 9/00

(52) U.S. Cl. CPC G03G 9/08755; G03G 21/20
USPC 430/105; 430/109.4; 430/137.1

(57) ABSTRACT

According to one embodiment, an erasable toner of the present embodiment includes a binder resin, an electron donating coloring agent, an electron accepting developer, and a discoloring temperature regulating agent, in which when measuring for the first time by differential thermal scanning calorimetry, an endothermic peak temperature Tg of the binder resin and an endothermic peak temperature Th of the discoloring temperature regulating agent satisfy Tg<Th and Th−Tg>25° C.

### CROSS-REFERENCE TO RELATED APPLICATION

This application is based upon and claims the benefit of priority from Japanese Patent Application No. 2013-006439, filed Jan. 17, 2013; the entire contents of which are incorporated herein by reference.

### FIELD

Embodiments described herein relate generally to a toner for developing an electrostatic charge image and a magnetic latent image in electrophotography, an electrostatic printing process, or the like, and particularly relate to an erasable toner.

### BACKGROUND

It has become possible to speed up and share information in an office environment due to the widespread use of computers, software, and networks. Computerization of information is fundamentally superior over paper in terms of the storage, accumulation, searchability, and the like of information, however, a paper medium has superiority in display (particularly perusal) and transmission of information, and the fact is that as the digitization of information progresses, the amount of paper used also increases. On the other hand, it is urgent that the energy consumption represented by CO₂ emission is reduced in each field, and if a paper medium used for temporal display and transmission of information can be recycled, it is possible to considerably contribute to reduction in energy consumption and resulting carbon emissions.

As such, in the related art, there is a technique in which paper is recycled by forming and fixing an image on the paper using a toner that is erasable by heat, and erasing the image at a temperature higher than the image fixing temperature. However, since the erasable toner includes a plurality of components such as a coloring agent, a developer, and a color erasing agent on a solid layer, a reaction of developing color and erasing color is not prompt and sufficient, and there may remain a mark after the erasing process due to components of the toner on a paper being decomposed being noticeable after erasing the image formed by an erasable toner.

In addition, a toner that is erasable by heat using a coloring material having temperature hysteresis characteristics is known, however, when the toner is manufactured or an image is fixed using this toner, there is some possibility of the image being inadvertently erased when the toner is unintentionally exposed to a temperature above the toner erasing temperature.

### DESCRIPTION OF THE DRAWINGS

FIG. 1 is a schematic diagram for illustrating an endothermic peak temperature of a toner by the DSC measurement of the present embodiment.

FIG. 2 is an outline configuration diagram showing an example of an image forming apparatus to which the toner of the present embodiment is applied.

### DETAILED DESCRIPTION

The present exemplary embodiment is made in consideration of the problem described above, and an object thereof is to provide a toner which forms an image which can be promptly erased, where an indicia on the print media of the erased image is not noticeable, the color of the toner is maintained during manufacturing thereof, and the color in the toner is not erased when fixing an image therewith.

In general, according to one embodiment, an erasable toner includes a binder resin, an electron donating coloring agent, an electron accepting developer, and a discoloring temperature regulating agent, in which when measuring for the first time by differential thermal scanning calorimetry, an endothermic peak temperature Tg of the binder resin and an endothermic peak temperature Th of the discoloring temperature regulating agent satisfy Tg<Th and Th−Tg>25° C. The first time measurement is the first raising of the temperature of the mixture from a low temperature below that of the expected endothermic peaks of the coloring agent, binder resin and discoloring agent, to a temperature above the expected endothermic peak of all three of these components.

Hereinafter, detailed description will be given with reference to the drawings.

An erasable toner of the present embodiment includes a binder resin, an electron donating coloring agent, an electron accepting developer, and a discoloring temperature regulating agent. When measuring the toner for the first time by differential thermal scanning calorimetry (the DSC measurement), an endothermic peak temperature Tg of the binder resin and an endothermic peak temperature Th of the discoloring temperature regulating agent satisfy Tg<Th and Th−Tg>25° C. Also, as used herein, color means the traditional colors of the spectrum, i.e., ranging from visible ultra violet to visible infra red, as well as black and white.

In the present embodiment, where the peak temperature Tg of the binder resin when measuring for the first time by DSC is lower than a peak temperature Th of the discoloring temperature regulating agent when measuring for the first time, and the difference in the peak temperatures is greater than 25° C., it is possible to obtain a toner in which the color forming capability is maintained during the manufacturing thereof, and the color is not erased during fixing of the image with the toner.

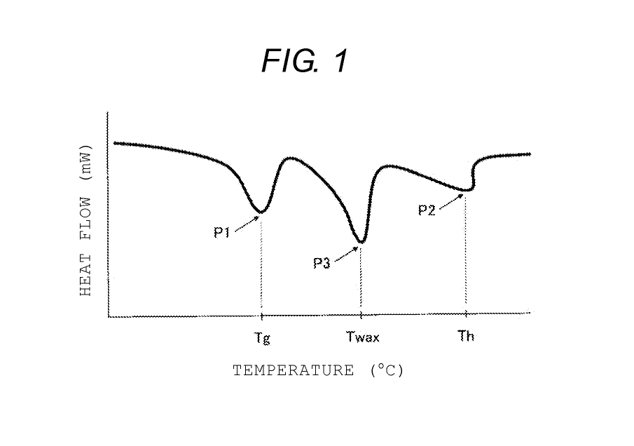

FIG. 1 is a diagram schematically showing an endothermic peak of an erasable toner of the present embodiment when measured by the DSC measurement for the first time.

As shown in FIG. 1, for the erasable toner, an endothermic peak P1 occurring from the binder resin, an endothermic peak P2 occurring from the discoloring temperature regulating agent, and an endothermic peak P3 occurring from a release agent are represented. The temperatures of peaks P1 and P2 are respectively the endothermic peak temperatures Tg and Th.

The endothermic peak temperature Tg of the binder resin is fundamentally determined from an endothermic peak when measuring for the second time, however, particularly when an amorphous resin is used as a binder resin, the endothermic peaks fluctuate when measuring for the first time and for the second time. Specifically, the peak temperature derived from the binder resin when measuring for the first time tends to be a higher temperature than the endothermic peak temperature measured for the second time. Furthermore, there are some cases when the endothermic peak of the discoloring temperature regulating agent does not appear when measuring for the second time due to characteristics thereof. In the present embodiment, a relationship between the endothermic peak temperature of the binder resin and the endothermic peak temperature of the discoloring temperature regulating agent when measuring for the first time in the DSC measurement is defined.

Electron Donating Coloring Agent

The electron donating coloring agent is a precursor compound of a color that displays the color as an image such as a letter, a figure, or the like when the toner is fixed on a print medium. As an electron donating coloring agent, a leuco dye can be used. The leuco dye is an electron donating compound capable of developing color by the electron accepting developer described later. For example, diphenylmethane phthalides, phenyl indolyl phthalides, indolyl phthalides, diphenylmethane azaphthalides, phenyl indolyl phthalides, fluorans, styrynoquinolines, and diazarhodamine lactones can be used.

Specifically, 3,3-bis(p-dimethylaminophenyl)-6-dimethylaminophthalide, 3-(4-diethylaminophenyl)-3-(1-ethyl-2-methylindole-3-yl)phthalide, 3,3-bis(1-n-butyl-2-methylindole-3-yl)phthalide, 3,3-bis(2-ethoxy-4-diethylaminophenyl)-4-azaphthalide, 3-(2-ethoxy-4-diethylaminophenyl)-3-(1-ethyl-2-methylindole-3-yl)-4-azaphthalide, 3-[2-ethoxy-4-(N-ethylanilino)phenyl]-3-(1-ethyl-2-methylindole-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl, spiro[5H-(1)benzopyrano(2,3-d)pyrimidine-5,1′(3′H)isobenzofuran]-3′-one, 2-(di-n-butylamino)-8-(di-n-butylamino)-4-methyl, spiro[5H-(1)benzopyrano(2,3-d)pyrimidine-5,1′(3′H)isobenzofuran]-3′-one, 2-(di-n-butylamino)-8-(diethylamino)-4-methyl, spiro[5H-(1) benzopyrano(2,3-d)pyrimidine-5,1′(3′H)isobenzofuran]-3′-one, 2-(di-n-butylamino)-8-(N-ethyl-N-isoamylamino)-4-methyl, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindole-3-yl)-4,5,6,7-tetrachlorophthalide, 3-(2-ethoxy-4-diethylaminophenyl)-3-(1-ethyl-2-methylindole-3-yl)-4,5,6,7-tetrachlorophthalide, 3-(2-ethoxy-4-diethylaminophenyl)-3-(1-pentyl-2-methylindole-3-yl)-4,5,6,7-tetrachlorophthalide, and the like are included. Furthermore, a pyridine-based, quinazoline-based, and bisquinazoline-based compound, and the like can be used. The above compounds may be used alone, or in combinations of two or more types.

Electron Accepting Developer

The electron accepting developer is an electron accepting compound for the electron donating coloring agent. For example, phenols, phenol metal salts, carboxylic acid metal salts, aromatic carboxylic acid, aliphatic carboxylic acid having 2 to 5 carbon atoms, benzophenones, sulfonic acid, sulfonic acid salts, phosphoric acids, phosphoric acid metal salts, acidic phosphoric acid esters, acidic phosphoric acid ester metal salts, phosphorous acids, phosphorous acid metal salts, monophenols, polyphenols, 1,2,3-triazole and a derivative thereof, and the like may be used, furthermore, as a substituent thereof, an alkyl group, an aryl group, an acyl group, an alkoxycarbonyl group, a carboxy group and an ester thereof, or a group containing an amide group, a halogen group, and the like, bis-type and tris-type phenol, and the like, a phenol-aldehyde condensation resin, and the like, and furthermore, a metal salt thereof may be used.

Specifically, phenol, o-cresol, t-butyl catechol, nonylphenol, n-octylphenol, n-dodecylphenol, n-stearylphenol, p-chlorophenol, p-bromophenol, o-phenylphenol, p-hydroxybenzoic acid n-butyl, p-hydroxybenzoic acid n-octyl, p-hydroxybenzoic acid benzyl, dihydroxybenzoic acid or a ester thereof, for example, 2,3-dihydroxybenzoic acid, 3,5-dihydroxybenzoic acid methyl, resorcin, gallic acid, dodecyl gallate, ethyl gallate, butyl gallate, propyl gallate, 2,2-bis(4-hydroxyphenyl)propane, 4,4-dihydroxydiphenyl sulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyflethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethylpropionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxy acetophenone, 2,5-dihydroxy acetophenone, 2,6-dihydroxy acetophenone, 3,5-dihydroxyacetophenone, 2,3,4-trihydroxy acetophenone, 2,4-dihydroxy benzophenone, 4,4′-dihydroxy benzophenone, 2,3,4-trihydroxy benzophenone, 2,4,4′-trihydroxy benzophenone, 2,2′,4,4′-tetrahydroxy benzophenone, 2,3,4,4′-tetrahydroxy benzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidene trisphenol, 4,4′-(1-methylethylidene)bisphenol, methylene tris-p-cresol, and the like may be used. The above compounds may be used alone or by combining two or more types thereof.

Discoloring Temperature Regulating Agent

The discoloring temperature regulating agent used in the present embodiment is a compound which inhibits a color developing reaction by the electron donating coloring agent and the electron accepting developer due to heat to be able to achromatize the three components system of the electron donating coloring agent, the electron accepting developer, and the discoloring temperature regulating agent.

In such a discoloring temperature regulating agent, particularly, the color developing and color erasing mechanism using the temperature hysteresis of a discoloring temperature regulating agent which is well-known in JP-A-60-264285, JP-A-2005-1369, JP-A-2008-280523, or the like is superior in terms of the instant erasability. If the mixture in which color is developed of the three components system is heated up to the specific temperature (a color erasing temperature) or more, it is possible to erase an image containing the toner, and, if the color is reached before the toner is used to form an image, to erase or eliminate the color in the toner or the fixed image. Furthermore, even though the mixture in which the color has been erased is cooled, a color erased state is maintained, unless the specific recoloring temperature or lower is attained, at which point the invertible color developing and color erasing reaction will again occur and the color developing reaction by the electron donating coloring agent and the electron accepting developer is reactivated again to return the material, whether in the toner or printed image condition, to the state of having or showing the color thereof. Particularly, the discoloring temperature regulating agent used in the present embodiment preferably satisfies a relationship in which the color erasing temperature (e.g., 110° C.) is higher than an ambient temperature (e.g., room temperature of 25° C.) and the recoloring temperature (e.g., −20° C.) is lower than an ambient temperature (e.g., room temperature of 25° C.)

The discoloring temperature regulating agent capable of causing such the temperature hysteresis, for example, includes alcohols, esters, ketones, ethers, and acid amides. Particularly, esters are preferable.

Specifically, carboxylic acid ester including a substituted aromatic ring, ester of carboxylic acid and aliphatic alcohol including an un-substituted aromatic ring, carboxylic acid ester including a cyclohexyl group in a molecule, ester of fatty acid and unsubstituted aromatic alcohol or phenol, ester of fatty acid and branched aliphatic alcohol, ester of dicarboxylic acid and aromatic alcohol or branched aliphatic alcohol, cinnamic acid dibenzyl, stearic acid heptyl, didecyl adipate, dilauryl adipate, dimyristyl adipate, dicetyl adipate, distearyl adipate, trilaurin, trimyristin, tristearin, dimyristin, distearin, and the like are included. The above may be used alone or by mixing two or more kinds.

In the present embodiment, in order to improve the color developing and color erasing effect of the toner, it is preferable that a core component including the electron donating coloring agent, the electron accepting developer, and the discoloring temperature regulating agent be encapsulated by a shell component. By encapsulating the core components, the color developing and color erasing effect of the toner is improved.

As a method of encapsulating, an interfacial polymerization method, a coacervation method, an In-Situ polymerization method, a drying method in liquid, a cured coating method in liquid, and the like are included. Particularly, an In-Situ polymerization method in which a melamine resin is used as a shell component and an interfacial polymerization method in which a urethane resin is used as a shell component are preferable. In a case of an In-Situ polymerization method, firstly, the electron donating coloring agent, the electron accepting developer, and the discoloring temperature regulating agent are dissolved and mixed to be emulsified in a water-soluble polymer or a surfactant aqueous solution. Afterward, it is possible to encapsulate by adding a melamine formalin pre-polymer aqueous solution and then heat and polymerize. In a case of an interfacial polymerization method, three components described above and a multivalent isocyanate pre-polymer are dissolved and mixed to be emulsified in a water-soluble polymer or a surfactant aqueous solution. Afterward, it is possible to encapsulate by adding a multivalent base such as diamine and diol and then heat and polymerize the mixture.

Binder Resin

As a resin used as a binder in the present embodiment, a polyester-based resin which is obtained by polycondensing a dicarboxylic acid component with a diol component through an esterification reaction is preferable. Since the glass transition temperature in a styrene-based resin is generally higher, compared with a polyester-based resin, the styrene-based resin has a disadvantage in a viewpoint of the low temperature fixing.

As a polyester resin used in the present embodiment, any of amorphous and crystalline can be used, and two or more kinds of polyester resins in which compositions are different may be mixed for use.

As an acid component of a polyester resin used in the present embodiment, for example, aromatic dicarboxylic acid such as terephthalic acid, phthalic acid or isophthalic acid and aliphatic carboxylic acid such as fumaric acid, maleic acid, succinic acid, adipic acid, sebacic acid, glutaric acid, pimelic acid, oxalic acid, malonic acid, citraconic acid, and itaconic acid, and the like may be used.

In addition, as an alcohol component, aliphatic diol such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol, alicyclic diol such as 1,4-cyclohexane diol and 1,4-cyclohexane dimethanol, ethylene oxide such as bisphenol A, a propylene oxide adduct, and the like may be used. In addition, the polyester component described above may be formed into a crosslinked structure using multivalent carboxylic acid having a valance of 3 or more such as 1,2,4-benzene tricarboxylic acid (trimellitic acid) and glycerin, or a multivalent alcohol component. Two or more kinds of polyester resins in which compositions are different may be mixed for use.

The glass transition temperature of the binder resin is preferably in a range from 45° C. to 70° C. If the glass transition temperature is lower than 45° C., heat-resisting conservation properties of the toner degenerate, and a gloss of the resin which remains is noticeable when the image is erased. On the other hand, if the glass transition point is higher than 70° C., the low temperature fixability of the toner degenerates, and the erasability of the image is deteriorated under heating. A range from 50° C. to 65° C. is more preferable.

Release Agent

As a release agent used in the present embodiment, for example, aliphatic hydrocarbon-based wax such as low molecular weight polyethylene, low molecular weight polypropylene, a polyolefin copolymer, polyolefin wax, paraffin wax, Fischer-Tropsch wax and a modified product thereof, vegetable-based wax such as candelilla wax, carnauba wax, vegetable wax, jojoba wax and rice wax, animal-based wax such as beeswax, lanolin, spermaceti, mineral-based wax such as montan wax, ozokerite, and ceresin, fatty acid amide such as linoleic acid amide, oleic acid amide, and lauric acid amide, a functional synthetic wax, silicone-based wax, and the like may be used.

Particularly, a release agent having an ester bond of a component of an alcohol component and a carboxylic acid component is preferable. A higher alcohol as an alcohol component, saturated fatty acid having a linear alkyl group, unsaturated fatty acid such as monoenoic acid, polyene acid, hydroxy fatty acid, and the like as a carboxylic acid component, may be used. Moreover, polyunsaturated carboxylic acid, maleic acid, fumaric acid, citraconic acid, itaconic acid, and the like may be used. Moreover, the release agent may be an anhydride thereof.

The softening point of the release agent is preferably 50° C. to 120° C., and more preferably 60° C. to 110° C., from the viewpoint of the low temperature fixability of an image.

Reactive Polymer

A reactive polymer having ability to crosslink with the binder resin in the present embodiment may be used. By adding the reactive polymer, it is possible to completely incorporate coloring material fine particles into the toner, the image density (ID) is improved and an image defect such as fogging is reduced when an image is formed using the toner.

As such a reactive polymer, for example, there is a reactive polymer containing an oxazoline group. In the present embodiment, in order to manufacture the toner in a water based process, the reactive polymer is preferably water-soluble. Specifically, for example, EPOCROS WS-500, EPOCROS WS-700 (all trade names, manufactured by NIPPON SHOKUBAI CO., LTD.), and the like are included. In addition, as other water-soluble reactive polymers, a compound containing an epoxy group can be included. Specifically, for example, DENACOL EX313, 314, 421, 512, 521 (all trade names, manufactured by Nagase ChemteX Corporation), and the like may be used. Compounds containing an epoxy group may be used alone when the binder resin is a resin including a carboxyl group (a polystyrene-based or polyester-based resin containing an acid value), or a resin containing an amino group or a hydroxy group may be added. Beyond that, a compound containing a carbodiimide group may also be used. A polycarbodiimide resin in which a carbodiimide equivalent is approximately from 300 to 800 is preferable. For example, SV-02, V-02, V-02-L2, V-04 (all trade names, manufactured by Nisshinbo Chemical Inc.), and the like may be used.

Charge Controlling Agent

In the present embodiment, a charge controlling agent, or the like, may be blended with the toner composition to control the quantity of electric charge of the toner particles caused by frictional/electrostatic charging. As a charge controlling agent, a metal containing azo compound is used, and a complex or a complex salt of which a metallic element is iron, cobalt, and chromium, or a mixture thereof is preferable. In addition, a metal containing salicylic acid derivative compound is also used, and a complex or a complex salt of which a metallic element is zirconium, zinc, chromium and boron, or a mixture thereof is preferable.

External Additive

In the present Example, in order to adjust the liquidity or charging characteristics with respect to the toner particles, from 0.01% by weight to 20% by weight of inorganic fine particles may be externally added and mixed, with respect to the toner particles. As such inorganic fine particles, silica, titania, alumina, strontium titanate, tin oxide, and the like are included. The inorganic fine particles can be used alone or by mixing two or more types thereof. In addition, it is preferable that inorganic fine particles in which the surface treatment is conducted by a hydrophobizing agent be used, from the viewpoint of an improvement of environmental stability. In addition, resin fine particles which are 1 μm or less other than such inorganic fine particles may be externally added for an improvement of cleaning performance to remove toner in the image fixing device.

Manufacturing Method of Toner

The method of making the erasable toner of the present embodiment is not particularly limited, as long as it is a manufacturing method in which the color is not erased during the manufacturing of the toner. However, for example, in a kneading and grinding method which is conventionally used, the general kneading temperature when kneading is higher than the color erasing temperature of a coloring material contained in the toner of the present embodiment. For this reason, at the normal kneading temperature, the color in the toner would be erased when kneading. In the present embodiment, it is preferable that a so-called chemical manufacturing method in which an atomizing product of the toner component is manufactured to make the atomizing product have the desired particle diameter of the toner by an aggregation fusion method be performed.

In the chemical manufacturing method, after toner particles are aggregated, a fusion treatment is performed. The fusion treatment is performed in order to smooth the surface of the toner to enhance the roundness of the toner particles. It is preferable that a fusion temperature Tf satisfy the following formula (1) in the relationship between the endothermic peak temperature Tg derived from the binder resin for the first time in the DSC measurement and the endothermic peak temperature Th derived from the discoloring temperature regulating agent for the first time in DSC measurement.

Tg−5<Tf<Th (1)

If the fusion temperature Tf is greater than the endothermic peak temperature Tg of from the binder resin measured for the first time by a DSC measurement by 5° C. or more, the aggregated toner particles are difficult to fuse. On the other hand, if the fusion temperature Tf is higher than the endothermic peak temperature Th of the discoloring temperature regulating agent at the first DSC measurement, the color of the coloring material in the toner is erased during the fusion treatment.

Image Fixation

Generally, it is insufficient that only a fixing temperature for fixing the toner after an image is formed is higher than the glass transition point of the binder resin, and it is necessary to be the vicinity of a melting temperature Tm of the toner. In the present embodiment, in order to not erase the color of an image when fixing, the melting temperature Tm of the toner needs to be lower than the color erasing temperature Th.

Further, the melting temperature Tm (2 mm offset temperature) was set to a temperature where the toner flows out of molten material by 2 mm by heating up from 30° C. at 2.5° C./min with 10 kg of a load and an orifice diameter of 1 mm by a flow tester measurement.

In this manner, the obtained erasable toner according to the present embodiment, for example, is accommodated in a toner cartridge, installed on an image forming apparatus such as MFP (Multi-Functional Peripheral) provided with a system of fixing by heat, and used for an image formation by electrophotography.

In addition, the toner according to the present embodiment is used in a system in which the color of an image is erased at a color erasing temperature which is higher than the fixing temperature.

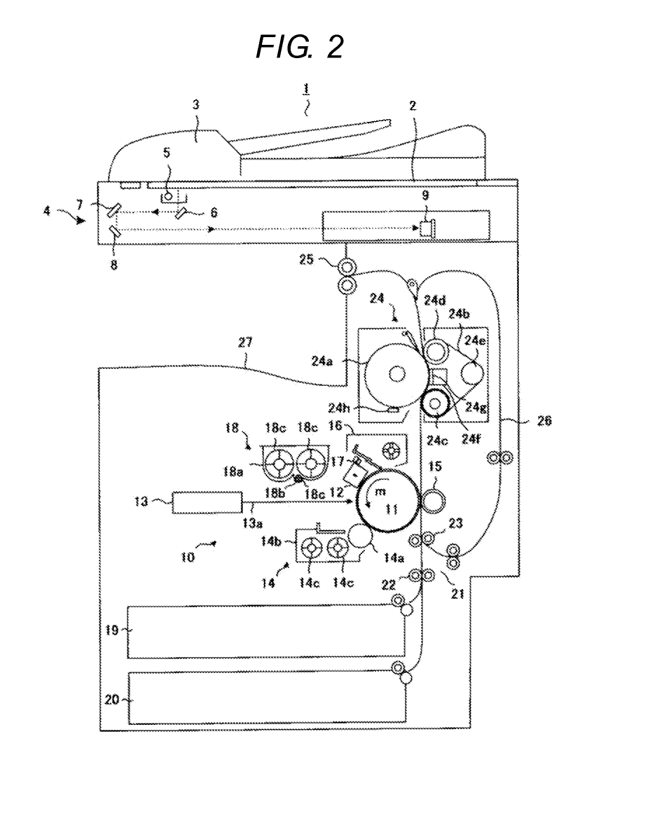

Hereinafter, detailed description will be given of an example of an image forming apparatus to which an erasable toner according to the present embodiment is applied with reference to FIG. 2.

FIG. 2 is a diagram showing an outline configuration of an electrophotographic image forming apparatus to which an erasable toner according the present embodiment is applied.

As shown in FIG. 2, an image forming apparatus 1 is provided with a document loading tray 2 on the upper surface part. An automatic document feeding apparatus 3 is provided on the upper side of the document loading tray 2, and a scanner 4 that exposes a document placed on the document loading tray 2 or a document sent by the automatic document feeding apparatus 3 is provided on the lower side. The scanner 4 is provided with a light source 5 that irradiates the document with light, a first reflecting mirror 6 that reflects the light reflected from the document in a predetermined direction, and second and third reflecting mirrors 7 and 8 that reflect the light reflected from the first reflecting mirror 6 to a light receiving element 9 that receives the light reflected from the third reflecting mirror 8.

An image forming unit 10 is provided at the central part in the image forming apparatus 1. The image forming unit 10 includes a photosensitive drum 11 that is rotatable in the direction of the arrow m as an image carrier. The photosensitive drum 11 includes an organic photo conductor (OPC) on the surface thereof and it rotates at a predetermined peripheral velocity, for example, the surface of the drum 11 moves at 136 m/s. An electrifying apparatus 12 that charges the surface of the photosensitive drum 11, a laser exposure unit 13 which performs an image exposure of the surface of the photosensitive drum 11, a developing apparatus 14 that supplies the erasable toner according to the present embodiment to an electrostatic latent image on the photosensitive drum 11, a transfer roller 15 that transfers an toner image on the photosensitive drum 11 to a print media to be transferred such as a paper, a cleaning apparatus 16 that removes and collects the transfer residual toner remained on the photosensitive drum 11, and a neutralizing lamp 17 that neutralizes the photosensitive drum 11 are provided at the circumference of the photosensitive drum 11, along the direction of rotation thereof in the recited order.

The developing apparatus 14 is provided with a container 14b provided with a developing roller 14a, and a mixer 14c that stirs and feeds the toner and a carrier in the container 14b. The toner is supplied to the developing roller 14a after mixing and feeding with the carrier. The developing roller 14a supplies the toner to the electrostatic latent image on the photosensitive drum 11.

Further, the recycling mechanism that replenishes the used toner collected by the cleaning apparatus 16 to the developing apparatus 14 to use again may be provided. In this case, the developing apparatus 14 and the cleaning apparatus 16 are connected through the recycling mechanism.

A toner cartridge 18 is provided at the upper part of the image forming unit 10. The toner cartridge 18 includes a container 18a that accommodates the toner, a toner supply port 18b that supplies the toner in the container 18a to the developing apparatus 14, and a stirring member 18c that stirs the toner in the container 18a and feeds it to the toner supply port 18b. The toner cartridge 18 is freely detachable to the main body of the image forming apparatus 1, and the toner supply port 18b is connected with the developing apparatus 14 by setting the toner cartridge 18 in the image forming apparatus 1. The toner cartridge 18 supplies the toner filled in the toner cartridge 18 to the developing apparatus 14. The supply of the toner is appropriately conducted according to the density of the toner in the developing apparatus 14.

Paper feeding cassettes 19 and 20 on the lower part side in the image forming apparatus 1 are provided. Papers are sent from the paper feeding cassettes 19 and 20. The papers are fed upward through a feeding system 21. The feeding system 21 includes a pair of feeding rollers 22, a pair of resist rollers 23, and a pair of paper discharging rollers 25 located at the downstream of the fixing apparatus 24. In addition, a re-feeding apparatus 26 to transfer to both sides of the papers is provided.

The fixing apparatus 24 includes a heat roller 24a and a pressure belt 24b that is endlessly rotatable. The pressure belt 24b is tightly stretched by winding around a belt heat roller 24c that is located at the upstream side in a paper feeding direction, a pressure roller 24d that is located at the downstream side in a paper feeding direction, and a tension roller 24e. The pressure belt 24b is abutted over a predetermined range on the circumferential surface of the heat roller 24a between the belt heat roller 24c and the pressure roller 24d to form a nip. A pressure pad 24g is retained in a pressure pad holder 24f arranged inside of the pressure belt 24b, and the pressure pad 24g makes the pressure belt 24b apply pressure and contact against the heat roller 24a at the central part of the nip. The heat roller 24a and the belt heat roller 24c are internally provided with, for example, a halogen lump as a heat source. The surface temperatures of the heat roller 24a and the belt heat roller 24c are respectively detected by a thermistor 24h to control so as to be a predetermined desired image fixing temperatures.

When an image is formed, the document on the document loading tray 2 is irradiated with light from the light source 5. The light is reflected from the document and is received in the light receiving element 9 through the first to third reflecting mirrors 6 to 8 to read the image on the document. The surface of the photosensitive drum 11, which is negatively charged by the electrifying apparatus 12 in advance, is irradiated with a laser light 13a from the laser exposure unit 13, based on the read document image information. In this manner, the surface potential of the photosensitive drum 11 approaches 0 according to the density of an image in a region corresponding to an image part of the document to form the electrostatic latent image. The electrostatic latent image is opposed to the developing apparatus 14 by the rotation of the photosensitive drum 11 and adsorbs the toner supplied through the carrier at this position to become a toner image (a visible image). Further, the laser exposure unit 13 irradiates with the laser light 13a based on the image information output from a computer or the like which is connected with the image forming apparatus 1 by a wired or wireless device, in addition to reading image information from a document on the document loading tray 2 to also form the electrostatic latent image.

After the paper supplied from a paper feeding cassettes 19 or 20 is aligned by the resist roller 23, the paper is sent to pass between the photosensitive drum 11 and the transfer roller 15 and the toner image on the photosensitive drum 11 is transferred. The paper in which the toner image is transferred is fed to the fixing apparatus 24, and the image is fixed on the paper by applying pressure as well as heating when passing through the nip. After fixing the image, the paper is discharged onto the paper discharging tray 27 through a pair of paper discharging rollers 25.

The transferred residual toner which is not transferred to the paper and remains on the photosensitive drum 11 is removed by the cleaning apparatus 16. After removing the transfer residual toner, the photosensitive drum 11 is neutralized by a neutralizing lamp 17.

Due to the development described above, if the toner in the developing apparatus 14 is consumed, the erasable toner according to the present embodiment from the toner cartridge 18 is replenished. In addition, when including the toner recycling mechanism, after collecting by the cleaning apparatus 16, the removed transfer residual toner is returned to the developing apparatus 14 as used toner to be used again.

### EXAMPLE

Hereinafter, the present embodiment will be described in more detail showing specific examples. Further, unless otherwise specified, ‘%’ and ‘part’ are based on weight in the following description.

Manufacturing of Coloring Material

Coloring Material A

The components including 2 parts of 3-(4-diethylamino-2-hexyloxyphenyl)-3-(1-ethyl-2-methylindole-3-yl)-4-azaphthalide as a leuco dye, 4 parts of 1,1-bis(4′-hydroxyphenyl) hexafluoropropane and 4 parts of 1,1-bis(4′-hydroxyphenyl)n-decane as a developer, 50 parts of diester of 1,10-decane dicarboxylic acid and 2-(4-benzyloxyphenyl) ethanol as a discoloring temperature regulating agent are uniformly heated and dissolved to mix 30 parts of an aromatic multivalent isocyanate prepolymer and 40 parts of ethyl acetate as an encapsulated agent.

After the obtained solution was emulsified and dispersed in 300 parts of 8% polyvinyl alcohol aqueous solution and was stirred continuously for 1 hour at 90° C., 2.5 parts of water-soluble aliphatic modified amine as a reactant was added and the mixture was further continuously stirred for 6 hours to obtain encapsulated toner particles. The volume median diameter of the particles was 3 μm. In addition, the complete color erasing temperature was 86° C.

Further, the complete color erasing temperature is a temperature in which the image density (ID) becomes 0.10 or less.

Coloring Material B

The coloring material B was manufactured in the same way as the coloring material A except using diester of suberic acid and 2-(4-benzyloxyphenyl)ethanol instead of diester of 1,10-decane dicarboxylic acid and 2-(4-benzyloxyphenyl) ethanol added as a discoloring temperature regulating agent of the coloring material A. The volume median toner particle diameter was 3 μm. In addition, the complete color erasing temperature was 97° C.

Coloring Material C

The coloring material C was manufactured in the same way as the coloring material A except using diester of 1,18-octadecane dicarboxylic acid and 2-[4-(2-methylbenzyloxy)phenyl]ethanol instead of diester of 1,10-decane dicarboxylic acid and 2-(4-benzyloxyphenyl) ethanol added as a discoloring temperature regulating agent of the coloring material A. The volume median toner particle diameter was 3 μm. In addition, the complete color erasing temperature was 68° C.

Manufacturing of Binder Resin

Amorphous Polyester Resin A

After 53.1 parts of polyoxypropylene (2.2)-2,2-bis(4-hydroxyphenyl)propane, 21.1 parts of polyoxyethylene(2.0)-2,2-bis(4-hydroxyphenyl)propane, 22.6 parts of fumaric acid, 3.2 parts of adipic acid, 0.1 parts of t-butyl catechol, and 0.5 parts of tin octoate were put in, heated up to 210° C. and reacted at 210° C. under a nitrogen atmosphere, furthermore, a condensation reaction was conducted until reaching the desired softening point at 8.3 KPa under reduced pressure to obtain an amorphous polyester resin A.

Amorphous Polyester Resin B

After 83.3 parts of polyoxypropylene (2.2)-2,2-bis(4-hydroxyphenyl)propane, 0.8 parts of polyoxyethylene(2.0)-2,2-bis(4-hydroxyphenyl)propane, 15.9 parts of terephthalic acid, and 0.3 parts of dibutyl tin oxide were put in, heated up to 230° C. and reacted for 5 hours under a nitrogen atmosphere, furthermore, by reacting under reduced pressure, an amorphous polyester resin B was obtain.

Manufacturing of release agent dispersing liquid A

480 parts of deionized water and 4.3 parts of an alkenyl succinic acid dipotassium aqueous solution (trade name: LATEMUL ASK, manufactured by Kao Corporation, the effective concentration 28%) were put into a beaker with a volume of 1 L to disperse 120 parts of carnauba wax. The treatment was performed for 30 minutes by an ultrasonic homogenizer US-600T (manufactured by NISSEI Corporation) with maintaining the dispersion liquid at from 90° C. to 95° C. to disperse. After cooling, by adding deionized water and adjusting the solid content to 20%, a release agent dispersing liquid A was obtained. The volume median diameter of the obtained release agent dispersing liquid A was 0.42 μm.

### Example 1

After 600 g of the amorphous polyester resin A, 40 g of sodium dodecylbenzenesulfonate (trade name: NEOPELEX G-15 manufactured by Kao Corporation, the solid content: 15%) as an anionic surfactant, 6 g of polyoxyethylene (26 mol) oleylether (trade name: EMULGEN 430, manufactured by Kao Corporation) as a nonionic surfactant, and 218 g of 5% potassium hydroxide aqueous solution were dispersed at 25° C. while stirring at 200 r/min in a stainless-steel kettle with a volume of 5 L, the temperature was heated up to 90° C. The content was stabilized at 90° C. and was maintained for 2 hours while stirring. Subsequently, 1,076 g of deionized water was added dropwise at 6 g/min to obtain an emulsion. After the emulsion was cooled, the toner binder resin dispersing liquid A was obtained by passing the mixture through a metallic mesh. The volume median diameter of resin fine particles in the obtained toner binder resin dispersing liquid A was 0.16 μm. The solid content concentration was 32%.

The obtained toner binder resin dispersing liquid A (the effective solid content 56.7 parts), 10 parts of the coloring material A, and the release agent A (the effective solid content 5 parts) were mixed, and 18 parts of ammonium sulfate as an aggregation agent was added to aggregate at 45° C. When the particle diameter grew to 8 μm, the toner binder resin dispersing liquid A (the effective solid content 28.3 parts) was added to encapsulate the toner.

After that, after 0.2 parts of diethylenetriamine was added, with respect to the solid content of the toner, 1.0 part of an epoxy compound DENACOL EX313 (manufactured by Nagase ChemteX Corporation) was added and heated at 45° C. for 5 hours.

After that, 6.7 parts of EMAL E-27C (manufactured by Kao Corporation) as a dispersing agent was fed, heated up to 55° C. and left at the fusion temperature 55° C. for 2 hours to fuse the toner. The volume median diameter of the toner particles was 10 μm. Afterward, the toner was washed by pure water and dried until the water density became 1% or less. After that, 3.0% of SiO (trade name: NAX50, manufactured by Nippon Aerosil Co., Ltd.) and 0.3% of TiO (trade name: NKT90, manufactured by Nippon Aerosil Co., Ltd.) were externally added as an external additive, with respect to 100% of the toner.

### Example 2

The toner was manufactured in the same way as Example 1 except using the amorphous polyester resin B instead of the amorphous polyester resin A and the coloring material B instead of the coloring material A, and setting the fusion temperature to 65° C.

### Example 3

The toner was manufactured in the same way as Example 1 except not adding diethylenetriamine and an epoxy compound DENACOL EX313 (manufactured by Nagase ChemteX Corporation).

### Comparative Example 1

The toner was manufactured in the same way as Example 1 except using the coloring material C instead of the coloring material A, and setting the fusion temperature to 56° C.

### Comparative Example 2

The toner was manufactured in the same way as Example 2 except using the coloring material A instead of the coloring material B, and setting the fusion temperature to 70° C.

Evaluation

DSC Peak Temperature

As to the obtained toners of Examples and Comparative Examples, the DSC measurement was performed by Q-2000 (manufactured by TA INSTRUMENTS).

The measured temperature was from 0° C. to 180° C. and the temperature was elevated at a temperature rise rate of 10° C./min Afterward, the temperature of the toner which was heated up to 180° C. was reduced to 0° C. at a temperature reduction rate of 10° C./min. The operation was repeated twice. When measuring for the first time, i.e., during the first temperature rise step, the endothermic peak temperature Tg derived from the binder resin and the endothermic peak temperature Th derived from the coloring material (the discoloring temperature regulating agent) are shown in Table 1.

2 Mm Offset Temperature

As to the obtained toners of Examples and Comparative Examples, a flow tester measurement was performed by CFT-500D (manufactured by Shimazu Corporation). The melting temperature (2 mm offset temperature) Tm was set to a temperature where the toner flows out of molten material is 2 mm by heating up from 30° C. at 2.5° C./min with 10 kg of a load and an orifice diameter of 1 mm. The evaluation results are shown in Table 1.

Image Density (ID)

The obtained toners of Examples and Comparative Examples were mixed with ferrite carriers respectively coated by a silicone resin, or the like to produce a developer.

A fixing unit temperature and a paper feeding speed were adjusted to 85° C. and 40 mm/sec by an MFP using the obtained developer, and 300 patches of squares of 1.0 cm² (vertically 15 rows and horizontally 20 rows, with respect to the feeding direction) on a ppc paper (P-50s) manufactured by TOSHIBA CORPORATION were formed, and then the fixation was performed.

After fixing, the image density (ID) was measured by a reflection densitometer (RD-19I, manufactured by Gretagmacbeth). The evaluation results are shown in Table 1.

TABLE 1

| | | | | | Comparative | Comparative |
|---|---|---|---|---|---|---|
| | | Example 1 | Example 2 | Example 3 | Example 1 | Example 2 |
| DSC peak | Derived from resin | 54 | 66 | 54 | 54 | 66 |
| temperature | (Tg) | | | | | |
| (° C.) | Derived from coloring | 86 | 97 | 86 | 68 | 86 |
| | material (Th) | | | | | |

| | | | | | |
|---|---|---|---|---|---|
| 2 mm offset temperature (Tm)(° C.) | 84 | 94 | 82 | 84 | 93 |
| Fusion temperature when | 55 | 65 | 55 | 56 | 70 |
| manufacturing (° C.) | | | | | |
| Fixing temperature (° C.) | 85 | 90 | 85 | 85 | 90 |
| Image density (ID) | 0.55 | 0.52 | 0.42 | 0.09 | 0.12 |

As shown in Table 1, it is found that in Examples 1 to 3 using the erasable toner of the present embodiment, the color development is maintained after fixing. In addition, it is found that among these examples, in Example 3 in which the crosslinking treatment was not, the image density (ID) decreases, compared to Examples 1 and 2 in which the crosslinking treatment was performed, and as to the color developing properties, the toner in which a crosslinking treatment is performed is better.

On the other hand, it is found that even though the minimum fixing temperature of Comparative Example 1 is the same as the minimum fixing temperature (85° C.) of Examples 1 and 3, the color is erased after fixing. In addition, in the same way, it is found that even though the minimum fixing temperature of Comparative Example 2 is the same as the minimum fixing temperature (90° C.) of Examples 2, the color is erased after fixing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An erasable toner comprising:
a binder resin;
an electron donating coloring agent;
an electron accepting developer; and
a discoloring temperature regulating agent,
wherein, when measured for a first time by differential thermal scanning calorimetry, the endothermic peak temperature Tg of the binder resin and the endothermic peak temperature Th of the discoloring temperature regulating agent satisfy the relationship of Tg<Th and Th−Tg>25° C.

2. The toner according to claim 1,
wherein a 2 mm offset temperature Tm of the erasable toner by a flow tester measurement and the endothermic peak temperature Th of the discoloring temperature regulating agent satisfy the relationship of Tm<Th.

3. The toner according to claim 1 which is manufactured using an aggregation fusion method.

4. The toner according to claim 3,
wherein a fusion temperature Tf in the aggregation fusion method, the endothermic peak temperature Tg of the binder resin and the endothermic peak temperature Th of the discoloring temperature regulating agent satisfy the following formula.
Tg−5<Tf<TH (1)

5. The toner according to claim 1, wherein the toner fixes an image at a temperature of 85° C. or greater.

6. The toner according to claim 1, wherein the binder resin comprises a polyester.

7. The toner according to claim 1, wherein the binder resin comprises a cross-linked polyester.

8. The toner of claim 7, wherein the polyester is cross-linked with a reactive polymer.

9. The toner according to claim 1, wherein the endothermic peak temperature Th of the discoloring temperature regulating agent is less than the fixing temperature of the toner.

10. A method of manufacturing a toner, comprising the steps of:
forming toner particles having
a binder resin;
an electron donating coloring agent;
an electron accepting developer; and
a discoloring temperature regulating agent; and
heating the formed toner particles for a first time and measuring by differential thermal scanning calorimetry, the endothermic peak temperature Tg of the binder resin and the endothermic peak temperature Th of the discoloring temperature regulating agent, and determining whether the toner particles satisfy the relationships Tg<Th and Th−Tg>25° C.

11. The method of claim 10, further including the step of fusing the toner particles after forming the toner particles.

12. The method of claim 11, wherein the relationship between the temperature at which the toner particles are fused Tf, the endothermic peak temperature Tg of the binder resin and the endothermic peak temperature Th of the discoloring temperature regulating agent is Tg−5<Tf<Th.

13. The method of claim 11, further including the step of adding a charge controlling agent to the toner particles after the step of fusing.

14. A toner cartridge, comprising:
an enclosure; and
toner located within the enclosure comprising:
a binder resin;
an electron donating coloring agent;
an electron accepting developer; and
a discoloring temperature regulating agent, wherein;
when the toner is first heated in an evaluation thereof by differential thermal scanning calorimetry, the endothermic peak temperature Tg of the binder resin and the endothermic peak temperature Th of the discoloring temperature regulating agent satisfy the relationship of Tg<Th and Th−Tg>25° C.

15. The toner cartridge according to claim 14, wherein the toner is manufactured using an aggregation fusion method.

16. The toner cartridge according to claim 15,
wherein a fusion temperature Tf in the aggregation fusion method, the endothermic peak temperature Tg of the binder resin and the endothermic peak temperature Th of the discoloring temperature regulating agent satisfy the relationship Tg−5<Tf<TH.

17. The toner cartridge according to claim 14, wherein the toner fixes an image at a temperature of 85° C. or greater.

18. The toner cartridge according to claim 14, wherein the binder resin comprises a cross-linked polyester.

19. The toner cartridge of claim 18, wherein the polyester is cross-linked with a reactive polymer.

20. The toner cartridge according to claim 14, wherein the endothermic peak temperature Th of the discoloring temperature regulating agent is less than the fixing temperature of the toner.
